(19) United States
(12) Patent Application Publication
(10) Pub. No.: US 2019/0050710 A1
(43) Pub. Date: Feb. 14, 2019

(54) ADAPTIVE BIT-WIDTH REDUCTION FOR NEURAL NETWORKS

(71) Applicant: MIDEA GROUP CO., LTD., Foshan City (CN)

(72) Inventors: Aosen WANG, Buffalo, NY (US); Hua ZHOU, San Jose, CA (US); Xin CHEN, Los Altos, CA (US)

(21) Appl. No.: 15/676,701

(22) Filed: Aug. 14, 2017

(51) Int. Cl. G06N 3/04; G06N 3/08

(52) U.S. Cl. CPC G06N 3/04; G06N 3/08

(57) ABSTRACT

A method of providing an adaptive bit-width neural network model on a computing device, comprising: obtaining a first neural network model, wherein each layer of first neural network model has a respective set of parameters expressed with an original bit-width of the first neural network model; reducing a footprint of the first neural network model by using respective reduced bit-widths for storing the respective sets of parameters of different layers of the first neural network model, wherein: preferred values of the respective reduced bit-widths are determined through multiple iterations of forward propagation through the first neural network model using a validation data set while each of two or more layers of the first neural network model is expressed with different degrees of quantization until a predefined information loss threshold is met; and generating a reduced neural network model with quantized parameters expressed with the respective reduced bit-widths.

### BACKGROUND

This specification relates to machine learning real-time applications, and more specifically, to improving machine learning models for portable devices and real-time applications by reducing model size and computational footprint of the machine learning models and keeping same accuracy.

Machine learning has wide applicability in a variety of domains, including computer vision, speech recognition, machine translation, social network filtering, playing board and video games, medical diagnosis, and many other domains. A machine learning model, such as an artificial neural network (ANN), is a network of simple units (neurons) which receive input, change their internal states (activation) according to that input, and produce output depending on the input and the activation. The network is formed by connecting the output of certain neurons to the input of other neurons through a directed, weighted graph. The weights as well as the functions that compute the activations are gradually modified by an iterative learning process according to a predefined learning rule until predefined convergence is achieved. There are many variants of machine learning models and different learning paradigms. A convolutional neural network (CNN) is a class of feed-forward networks, composed of one or more convolutional layers with fully connected layers (corresponding to those of an ANN). A CNN has tied weights and pooling layers and can be trained with standard backward propagation. Deep learning models, such as VGG16 and different types of ResNet, are large models containing more than one hidden layer that can produce analysis results comparable to human experts, which make them attractive candidates for many real-world applications.

Neural network models typically have a few thousand to a few million units and millions of parameters. Deeper and high-accuracy CNNs require considerable computing resources, making them less practical for real-time applications or deployment on portable devices with limited battery life, memory, and processing power. The existing state-of-the-art solutions for deploying large neural network models (e.g., deep learning models) for various applications focus on two approaches, model reduction and hardware upgrades. Model reduction that focuses on reducing the complexity of the model structure often compromises the model's accuracy drastically, while hardware upgrades are limited by practical cost and energy consumption concerns. Therefore, improved techniques for producing effective, lightweight machine learning models are needed.

### SUMMARY

This disclosure describes a technique for producing a high-accuracy, lightweight machine learning model with adaptive bit-widths for the parameters of different layers of the model. Specifically, the conventional training phase is modified to promote parameters of each layer of the model toward integer values within an 8-bit range. After the training phase is completed, the obtained float-precision model (e.g., FP32 precision) optionally goes through a pruning process to produce a slender, sparse network. In addition, the full-precision model (e.g., the original trained model or the pruned model) is converted into a reduced adaptive bit-width model through non-uniform quantization, e.g., converting the FP32 parameters to their quantized counterparts with respective reduced bit-widths that have been identified through multiple rounds of testing using a calibration data set. Specifically, the calibration data set is forward propagated through a quantized version of the data model with different combinations of bit-widths for different layers, until a suitable combination of reduced bit-widths (e.g., a combination of a set of minimum bit-widths) that produce an acceptable level of model accuracy (e.g., with below a threshold amount of information loss, or with a minimum amount of information loss) is identified. The reduced adaptive bit-width model is then deployed (e.g., on a portable electronic device) to perform predefined tasks.

In one aspect, a method of providing an adaptive bit-width neural network model on a computing device, comprising: obtaining a first neural network model that includes a plurality of layers, wherein each layer of the plurality of layers has a respective set of parameters, and each parameter is expressed with a level of data precision that corresponds to an original bit-width of the first neural network model; reducing a footprint of the first neural network model on the computing device by using respective reduced bit-widths for storing the respective sets of parameters of different layers of the first neural network model, wherein: preferred values of the respective reduced bit-widths are determined through multiple iterations of forward propagation through the first neural network model using a validation data set while each of two or more layers of the first neural network model is expressed with different degrees of quantization corresponding to different reduced bit-widths until a predefined information loss threshold is met by respective response statistics of the two or more layers; and generating a reduced neural network model that includes the plurality of layers, wherein each layer of two or more the plurality of layers includes a respective set of quantized parameters, and each quantized parameter is expressed with the preferred values of the respective reduced bit-widths for the layer as determined through the multiple iterations.

In accordance with some embodiments, an electronic device includes one or more processors, and memory storing one or more programs; the one or more programs are configured to be executed by the one or more processors and the one or more programs include instructions for performing or causing performance of the operations of any of the methods described herein. In accordance with some embodiments, a non-transitory computer readable storage medium has stored therein instructions, which, when executed by an electronic device, cause the device to perform or cause performance of the operations of any of the methods described herein. In accordance with some embodiments, an electronic device includes: means for performing or causing performance of the operations of any of the methods described herein. In accordance with some embodiments, an information processing apparatus, for use in an electronic device, includes means for performing or causing performance of the operations of any of the methods described herein.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an environment in which an example machine learning system operates in accordance with some embodiments.

FIG. 2 is a block diagram of an example model generation system in accordance with some embodiments.

FIG. 3 is a block diagram of an example model deployment system in accordance with some embodiments.

FIG. 4 is an example machine learning model in accordance with some embodiments.

FIG. 5 is a flow diagram of a model reduction process in accordance with some embodiments.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first layer could be termed a second layer, and, similarly, a layer could be termed a first layer, without departing from the scope of the various described embodiments. The first layer and the second layer are both layers of the model, but they are not the same layer, unless the context clearly indicates otherwise.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

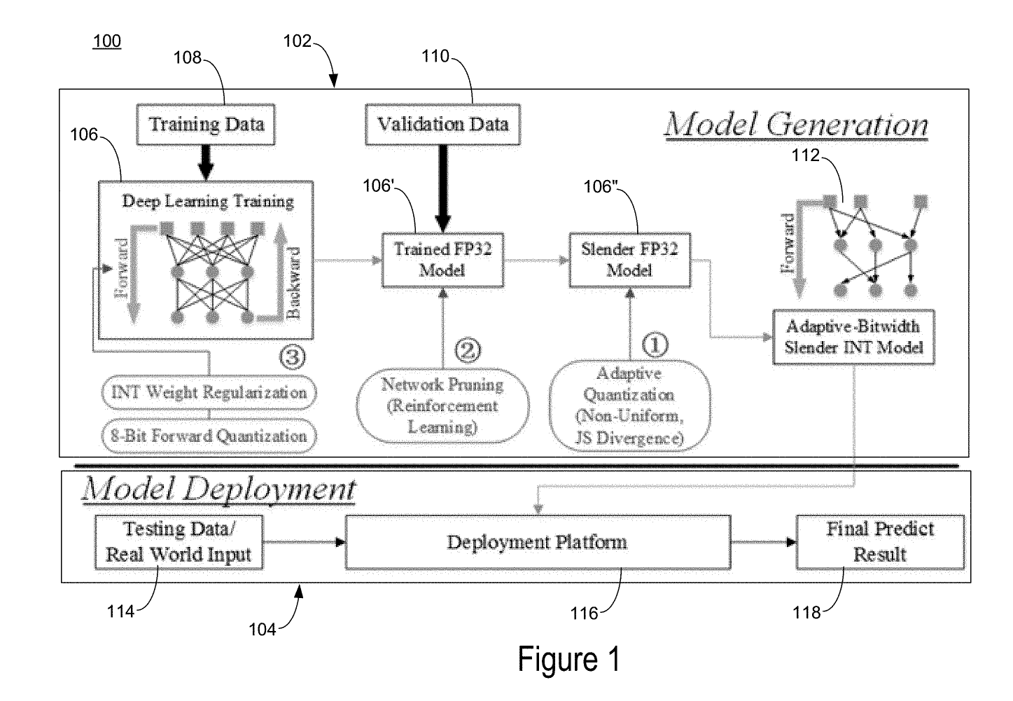

FIG. 1 is a block diagram illustrating an example machine learning system 100 in which a model generation system 102 and a model deployment system 104 operate. In some embodiments, the model generation system 102 is a server system with one or more processors and memory that are capable of large-scale computation and data processing tasks. In some embodiments, the model deployment system 104 is a portable electronic device with one or more processors and memory that is lightweight and with limited battery power, and less computation and data processing capabilities as compared to the server system 102. In some embodiments, the model generation system 102 and the model deployment system 104 are remotely connected via a network (e.g., the Internet). In some embodiments, the model deployment system 104 receives a reduced model as generated in accordance with the techniques described herein from the model generation system 102 over the network or through other file or data transmission means (e.g., via a portable removable disk drive or optical disk).

As shown in FIG. 1, the model generation system 102 generates a full-precision deep learning model 106 (e.g., a CNN with two or more hidden layers, and with its parameters (e.g., weights and biases) expressed in a single-precision floating point format that occupies 32 bits (e.g., FP32)) through training using a corpus of training data 108 (e.g., input data with corresponding output data). As used herein, “full-precision” refers to floating-point precision, and may include half-precision (16-bit), single precision (32-bit), double-precision (64-bit), quadruple-precision (128-bit), Octuple-precision (256-bit), and other extended precision formats (40-bit or 80-bit). In some embodiments, the training includes supervised training, unsupervised training, or semi-supervised training. In some embodiments, the training includes forward propagation through a plurality of layers of the deep learning model 106, and backward propagation through the plurality of layers of the deep learning model 106.

In some embodiments, during training, integer (INT) weight regularization and 8-bit quantization techniques are applied to push the values of the full-precision parameters of the deep learning model 106 toward their corresponding integer values, and reduce the value ranges of the parameters such that they fall within the dynamic range of a predefined reduced maximum bit-width (e.g., 8 bits). More details regarding the INT weight regularization and the 8-bit quantization techniques are described later in this specification.

In some embodiments, the training is performed using a model structure and training rules that are tailored to the specific application and input data. For example, if the learning model is for use in a speech recognition system, speech samples (e.g., raw spectral grams or linear filter-bank features) and corresponding text are used as training data for the deep learning model. In some embodiments, if the learning model is for use in computer vision, images or features and corresponding categories are used as training data for the learning model. In some embodiments, if the learning model is for use in spam detection or content filtering, content and corresponding content categories are used as training data for the learning model. A person skilled in the art would be able to select a suitable learning model structure and suitable training data in light of the applications, and in the interest of brevity, the examples are not exhaustively enumerated herein.

In some embodiments, once predefined convergence is achieved through the iterative training process, a full-precision learning model 106′ is generated. Each layer of the model 106′ has a corresponding set of parameters (e.g., a set of weights for connecting the units in the present layer to a next layer adjacent to the present layer, and optionally a set of one or more bias terms that is applied in the function connecting the two layers). At this point, all of the parameters are expressed with an original level of precision (e.g., FP32) that corresponds to an original bit-width (e.g., 32 bits) of the learning model 106. It is noted that, even though 8-bit quantization is applied to the parameters and intermediate results in the forward pass of the training process, a float-precision compensation scalar is added to the original bias term to change the gradients in the backward pass, and a resulting model 106′ still has all its parameters expressed in the original full-precision, but with a smaller dynamic range corresponding to the reduced bit-width (e.g., 8 bits) used in the forward pass. In addition, the input also remains in their full-precision form during the training process.

As shown in FIG. 1, after the training of the full-precision model 106 is completed, the resulting full-precision model 106′ optionally goes through a network pruning process. In some embodiments, the network pruning is performed using a threshold, and connections with weights that are less than a predefined threshold value (e.g., weak connections) are removed and the units linked by these weak connections are removed from the network, resulting in a lighter and sparse network 106″. In some embodiments, instead of using a threshold value as the criterion to remove the weaker connections in the model 106′, the pruning is performed with additional reinforcement training. For example, a validation data set 110 is used to test a modified version of model 106′. Each time the model 106 is tested using the validation data set, a different connection is removed from the model 106 or a random previously removed connection is added back to the model 106. The accuracy of the modified models with different combinations of connections are evaluated using the validation data set 110, and a predefined pruning criterion based on the total number of connections and the network accuracy (e.g., the criterion is based on an indicator value that is the sum of a measure of network accuracy and a reciprocal of total number of connections in the network) is used to determine the best combinations of the connections in terms of a balance between preserving network accuracy and reducing the network complexity.

As shown in FIG. 1, once the optional network pruning process is completed, a slender full-precision learning model 106″ is generated. The slender full-precision learning model 106″ is used as the base model for the subsequent quantization and bit-width reduction process to generate the reduced, adaptive bit-width model 112. In some embodiments, if network pruning is not performed, the trained full-precision model 106′ is used as the base model for the subsequent quantization and bit-width reduction process to generate the reduced, adaptive bit-width model 112. The reduced, adaptive bit-width model 112 is the output of the model generation system 102. The reduced, adaptive bit-width model 112 is then provided to the model deployment system 104 for use in processing real-world input in applications. In some embodiments, integer weight regularization and/or 8-bit forward quantization is not applied in the training process of the model 106, and conventional training methods are used to generate the full-precision learning model 106′. If the integer weight regularization and/or 8-bit forward quantization are not performed, the accuracy of the resulting adaptive bit-width model may not be as good, since the parameters are not trained to move toward the integer values and the dynamic range of the values may be too large for large reductions of bit-widths in the final reduced model 112. However, the adaptive bit-width reduction technique as described herein can nonetheless bring about desirable reduction in the model size without intractable amount loss in model accuracy. Thus, in some embodiments, the adaptive bit-width reduction as described herein may be used independent of the integer weight regularization and 8-bit forward quantization during the training stage, even though better results may be obtained if the two techniques are used in combination. More details of how the reduced bit-widths are selected for the different layers or parameters of the model 112 are determined and how the reduced bit-width model 112 is generated from the full-precision base model 106′ or 106″ in accordance with a predefined non-linear quantization method (e.g., logarithmic quantization) are provided later in this specification.

As shown in FIG. 1, once the reduced, adaptive bit-width model 112 is provided to a deployment platform 116 on the model deployment system 104, real-world input data or testing data 114 is fed to the reduced, adaptive bit-width model 112, and final prediction result 118 is generated by the reduced, adaptive bit-width model 112 in response to the input data. For example, if the model 112 is trained for a speech recognition task, the real-world input data may be a segment of speech input (e.g., a waveform or a recording of a speech input), and the output may be text corresponding to the segment of speech input. In another example, if the model 112 is trained for a computer vision task, the real-world input data may be an image or a set of image features, and the output may be an image category that can be used to classify the image. In another example, if the model 112 is trained for content filtering, the real-world input data may be content (e.g., web content or email content), and the output data may be a content category or a content filtering action. A person skilled in the art would be able to input suitable input data into the reduced, adaptive bit-width model 112, in light of the application for which the model 112 was trained, and obtain and utilize the output appropriately. In the interest of brevity, the examples are not exhaustively enumerated herein.

FIG. 1 is merely illustrative, and other configurations of an operating environment, workflow, and structure for the machine learning system 100 are possible in accordance with various embodiments.

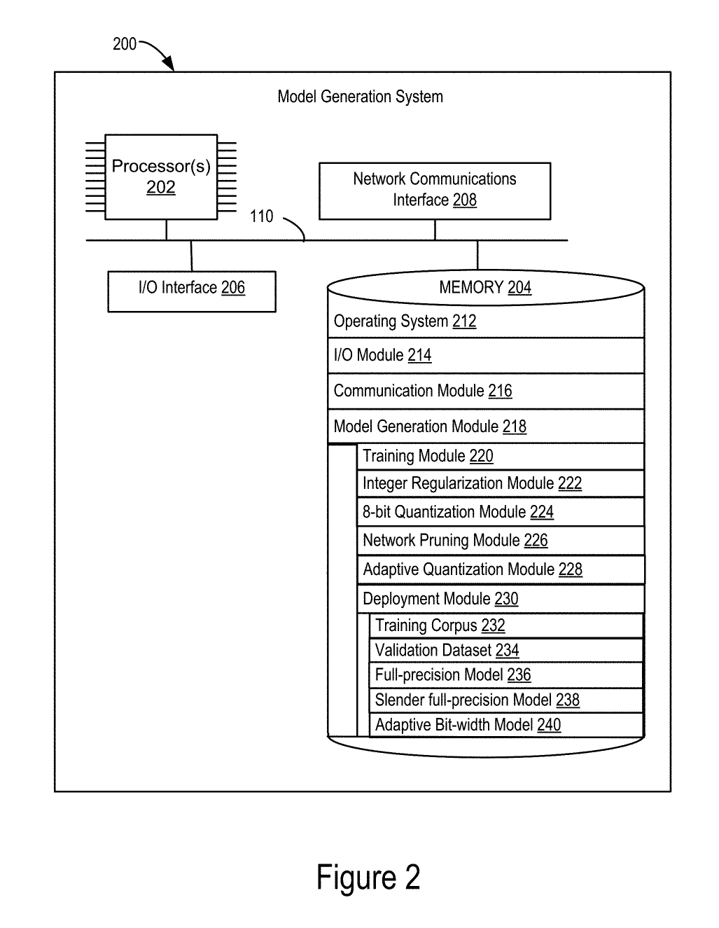

FIG. 2 is a block diagram of a model generation system 200 in accordance with some embodiments. The model generation system 200 is optionally used as the model generation system 102 in FIG. 1 in accordance with some embodiments. In some embodiments, the model generations system 200 includes one or more processing units (or “processors”) 202, memory 204, an input/output (I/O) interface 206, and an optional network communications interface 208. These components communicate with one another over one or more communication buses or signal lines 210. In some embodiments, the memory 204, or the computer readable storage media of memory 204, stores programs, modules, instructions, and data structures including all or a subset of: an operating system 212, an input/output (I/O) module 214, a communication module 216, and a model generation module 218. The one or more processors 202 are coupled to the memory 204 and operable to execute these programs, modules, and instructions, and reads/writes from/to the data structures.

In some embodiments, the processing units 202 include one or more microprocessors, such as a single core or multi-core microprocessor. In some embodiments, the processing units 202 include one or more general purpose processors. In some embodiments, the processing units 202 include one or more special purpose processors. In some embodiments, the processing units 202 include one or more server computers, personal computers, mobile devices, handheld computers, tablet computers, or one of a wide variety of hardware platforms that contain one or more processing units and run on various operating systems.

In some embodiments, the memory 204 includes high-speed random access memory, such as DRAM, SRAM, DDR RAM or other random access solid state memory devices. In some embodiments the memory 204 includes non-volatile memory, such as one or more magnetic disk storage devices, optical disk storage devices, flash memory devices, or other non-volatile solid state storage devices. In some embodiments, the memory 204 includes one or more storage devices remotely located from the processing units 202. The memory 204, or alternately the non-volatile memory device(s) within the memory 204, comprises a computer readable storage medium.

In some embodiments, the I/O interface 206 couples input/output devices, such as displays, a keyboards, touch screens, speakers, and microphones, to the I/O module 214 of the speech recognition system 200. The I/O interface 206, in conjunction with the I/O module 214, receive user inputs (e.g., voice input, keyboard inputs, touch inputs, etc.) and process them accordingly. The I/O interface 206 and the user interface module 214 also present outputs (e.g., sounds, images, text, etc.) to the user according to various program instructions implemented on the model generation system 200.

In some embodiments, the network communications interface 208 includes wired communication port(s) and/or wireless transmission and reception circuitry. The wired communication port(s) receive and send communication signals via one or more wired interfaces, e.g., Ethernet, Universal Serial Bus (USB), FIREWIRE, etc. The wireless circuitry receives and sends RF signals and/or optical signals from/to communications networks and other communications devices. The wireless communications may use any of a plurality of communications standards, protocols and technologies, such as GSM, EDGE, CDMA, TDMA, Bluetooth, Wi-Fi, VoIP, Wi-MAX, or any other suitable communication protocol. The network communications interface 208 enables communication between the model generation system 200 with networks, such as the Internet, an intranet and/or a wireless network, such as a cellular telephone network, a wireless local area network (LAN) and/or a metropolitan area network (MAN), and other devices. The communications module 216 facilitates communications between the model generation system 200 and other devices (e.g., the model deployment system 300) over the network communications interface 208.

In some embodiments, the operating system 202 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communications between various hardware, firmware, and software components.

In some embodiments, the model generation system 200 is implemented on a standalone computer system. In some embodiments, the model generation system 200 is distributed across multiple computers. In some embodiments, some of the modules and functions of the model generation system 200 are located on a first set of computers and some of the modules and functions of the model generation system 200 are located on a second set of computers distinct from the first set of computers; and the two sets of computers communicate with each other through one or more networks.

It should be noted that the model generation system 200 shown in FIG. 2 is only one example of a model generation system, and that the model generation system 200 may have more or fewer components than shown, may combine two or more components, or may have a different configuration or arrangement of the components. The various components shown in FIG. 2 may be implemented in hardware, software, firmware, including one or more signal processing and/or application specific integrated circuits, or a combination of thereof.

As shown in FIG. 2, the model generation system 200 stores the model generation module 218 in the memory 204. In some embodiments, the model generation module 218 further includes the followings sub-modules, or a subset or superset thereof: a training module 220, an integer weight regularization module 222, an 8-bit forward quantization module 224, a network pruning module 226, an adaptive quantization module 228, and a deployment module 230. In some embodiments, the deployment module 230 optionally performs the functions of a model deployment system, such that the reduced, adaptive bit-width model can be tested with real-world data before actual deployment on a separate model deployment system, such as on a portable electronic device.

In addition, as shown in FIG. 2, each of these modules and sub-modules has access to one or more of the following data structures and models, or a subset or superset thereof: a training corpus 232 (e.g., containing training data 108 in FIG. 1), a validation dataset 234 (e.g., containing the validation dataset 110 in FIG. 1), a full-precision model 236 (e.g., starting as untrained full-precision 106, transforms into a trained full-precision model 106′ after training), a slender full-precision model 238 (e.g., pruned model 106″ in FIG. 1), and a reduced, adaptive bit-width model 240 (e.g., reduced, adaptive bit-width model 112 in FIG. 1). More details on the structures, functions, and interactions of the sub-modules and data structures of the model generation system 200 are provided with respect to FIGS. 1, 4 and 5 and accompanying descriptions.

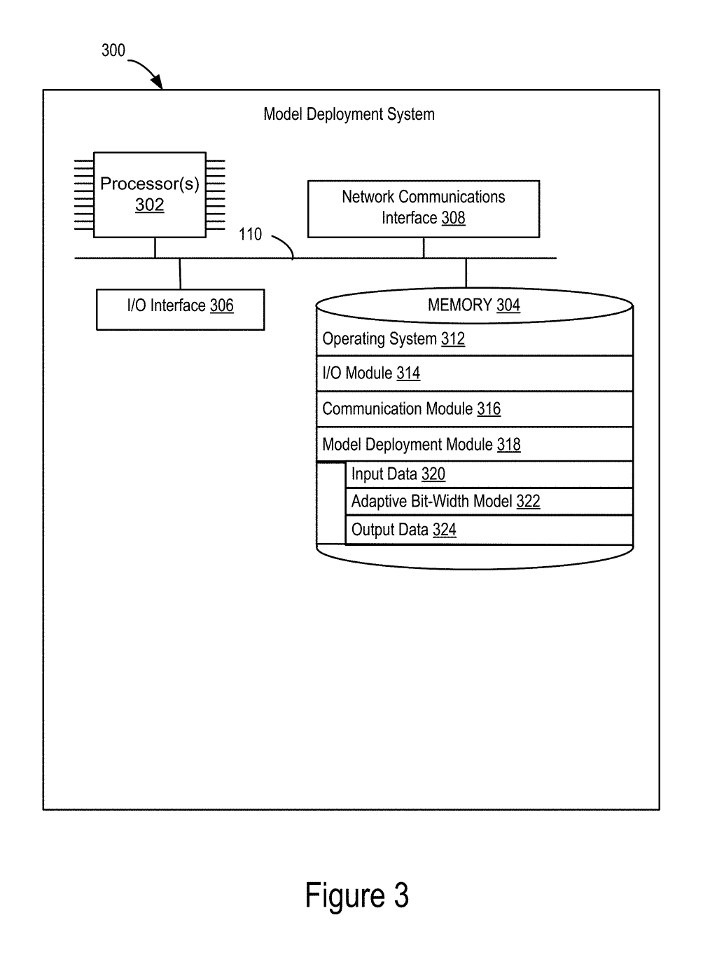

FIG. 3 is a block diagram of a model deployment system 300 in accordance with some embodiments. The model deployment system 300 is optionally used as the model deployment system 104 in FIG. 1 in accordance with some embodiments. In some embodiments, the model deployment system 300 includes one or more processing units (or “processors”) 302, memory 304, an input/output (I/O) interface 306, and an optional network communications interface 308. These components communicate with one another over one or more communication buses or signal lines 310. In some embodiments, the memory 304, or the computer readable storage media of memory 304, stores programs, modules, instructions, and data structures including all or a subset of: an operating system 312, an I/O module 314, a communication module 316, and a model deployment module 318. The one or more processors 302 are coupled to the memory 304 and operable to execute these programs, modules, and instructions, and reads/writes from/to the data structures.

In some embodiments, the processing units 302 include one or more microprocessors, such as a single core or multi-core microprocessor. In some embodiments, the processing units 302 include one or more general purpose processors. In some embodiments, the processing units 302 include one or more special purpose processors. In some embodiments, the processing units 302 include one or more server computers, personal computers, mobile devices, handheld computers, tablet computers, or one of a wide variety of hardware platforms that contain one or more processing units and run on various operating systems.

In some embodiments, the memory 304 includes high-speed random access memory, such as DRAM, SRAM, DDR RAM or other random access solid state memory devices. In some embodiments the memory 304 includes non-volatile memory, such as one or more magnetic disk storage devices, optical disk storage devices, flash memory devices, or other non-volatile solid state storage devices. In some embodiments, the memory 304 includes one or more storage devices remotely located from the processing units 302. The memory 304, or alternately the non-volatile memory device(s) within the memory 304, comprises a computer readable storage medium.

In some embodiments, the I/O interface 306 couples input/output devices, such as displays, a keyboards, touch screens, speakers, and microphones, to the I/O module 314 of the model deployment system 300. The I/O interface 306, in conjunction with the I/O module 314, receive user inputs (e.g., voice input, keyboard inputs, touch inputs, etc.) and process them accordingly. The I/O interface 306 and the user interface module 314 also present outputs (e.g., sounds, images, text, etc.) to the user according to various program instructions implemented on the model deployment system 300.

In some embodiments, the network communications interface 308 includes wired communication port(s) and/or wireless transmission and reception circuitry. The wired communication port(s) receive and send communication signals via one or more wired interfaces, e.g., Ethernet, Universal Serial Bus (USB), FIREWIRE, etc. The wireless circuitry receives and sends RF signals and/or optical signals from/to communications networks and other communications devices. The wireless communications may use any of a plurality of communications standards, protocols and technologies, such as GSM, EDGE, CDMA, TDMA, Bluetooth, Wi-Fi, VoIP, Wi-MAX, or any other suitable communication protocol. The network communications interface 308 enables communication between the model deployment system 300 with networks, such as the Internet, an intranet and/or a wireless network, such as a cellular telephone network, a wireless local area network (LAN) and/or a metropolitan area network (MAN), and other devices. The communications module 316 facilitates communications between the model deployment system 300 and other devices (e.g., the model generation system 200) over the network communications interface 308.

In some embodiments, the operating system 302 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communications between various hardware, firmware, and software components.

In some embodiments, the model deployment system 300 is implemented on a standalone computer system. In some embodiments, the model deployment system 300 is distributed across multiple computers. In some embodiments, some of the modules and functions of the model generation system 300 are located on a first set of computers and some of the modules and functions of the model generation system 300 are located on a second set of computers distinct from the first set of computers; and the two sets of computers communicate with each other through one or more networks. It should be noted that the model deployment system 300 shown in FIG. 3 is only one example of a model deployment system, and that the model deployment system 300 may have more or fewer components than shown, may combine two or more components, or may have a different configuration or arrangement of the components. The various components shown in FIG. 3 may be implemented in hardware, software, firmware, including one or more signal processing and/or application specific integrated circuits, or a combination of thereof.

As shown in FIG. 3, the model deployment system 300 stores the model deployment module 318 in the memory 304. In some embodiments, the deployment module 318 has access to one or more of the following data structures and models, or a subset or superset thereof: input data 320 (e.g., containing real-world data 114 in FIG. 1), the reduced, adaptive bit-width model 322 (e.g., reduced, adaptive bit-width model 112 in FIG. 1, and reduced, adaptive bit-width model 240 in FIG. 2), and output data 324. More details on the structures, functions, and interactions of the sub-modules and data structures of the model deployment system 300 are provided with respect to FIGS. 1, 4, and 5, and accompanying descriptions.

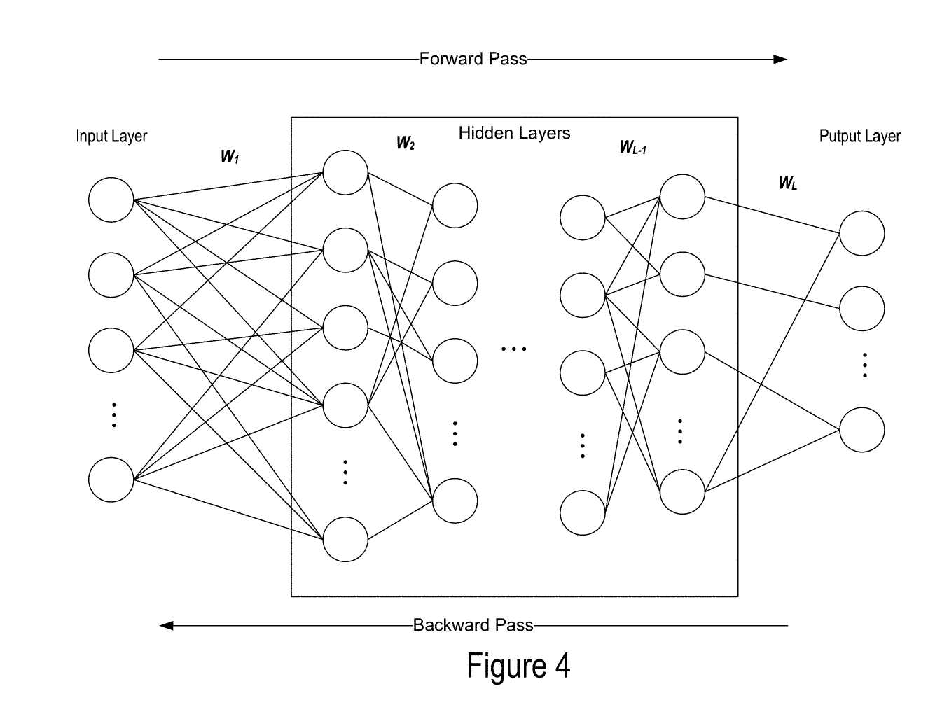

FIG. 4 illustrate the structure and training process for a full-precision deep learning model (e.g., an artificial neural network with multiple hidden layers). The learning model includes a collection of units (or neurons) represented by circles, with connections (or synapses) between them. The connections have associated weights that each represent the influence that an output from a neuron in the previous layer (e.g., layer i) has on a neuron in the next layer (e.g., layer i+l). A neuron in each layer adds the outputs from all of the neurons that connect to it from the previous layer and apply an activation function to obtain a response value. The training process is a process for calibrating all of the weights Wi for each layer of the learning model using a training data set which is provided in the input layer.

The training process typically includes two steps, forward propagation and backward propagation, that are repeated multiple times until a predefined convergence condition is met. In the forward propagation, the set of weights for different layers are applied to the input data and intermediate results from the previous layers. In the backward propagation, the margin of error of the output is measured, and the weights are adjusted accordingly to decrease the error. The activation function can be linear, rectified linear unit, sigmoid, hyperbolic tangent, or other types.

Conventionally, a network bias term b is added to the sum of the weighted outputs from the previous layer before the activation function is applied. The network bias provides the necessary perturbation that helps that network to avoid over fitting the training data. Below is a sample of workflow of a conventional neural network:

The training starts with the following components:

Input: image I_{n×m}, Output: label B_{k×1}, and Model: L-layer neural network.

Each layer i of the L-layer neural network is described as

y_{p×q}=g(W_{p*q}×x_{q×1}+b_{p×1}),

where y is a layer response vector, W is weight matrix, x is an input vector, g(x)=max(0,x) is an activation function and b is a bias vector. (Note that p and q are the dimensions of the layer and will be different in different layers).

```
//Training Phase
  While res has not converged:
  //Network Forward pass
  x₁=I
  For i = 1 to L:
    yᵢ=g(Wᵢ×xᵢ+bᵢ)
    xᵢ₊₁=yᵢ
res=½ ∥y_{L}-B∥₂  //a measure of margin of error//
//Backward pass
For i = L to 1:
    ${W}_{i} = {W}_{i} - γ \frac{\partial res}{\partial {W}_{i , j}} // γ is a parameter$
    ${b}_{i} = {b}_{i} - γ \frac{\partial res}{\partial {b}_{i , j}}$
```

The result of the training includes: Network weight parameters W for each layer, the network bias parameter b for each layer.

```
//Testing Phase: To classify an unseen image Iᵤₙ
  x₁=Iᵤₙ
  For i = 1 to L:
    yᵢ=g(Wᵢ×xᵢ+bᵢ)
    xᵢ₊₁=yᵢ
  Return y_{L}
```

In the present disclosure, in accordance with some embodiments, an integer (INT) weight regularization term is added to the weights W of each layer, where Wᵢ is the weights of layer i, and └Wᵢ┘ is the element-wise integer portions of the weights Wᵢ. With this regularization, the training will take the decimals of the weights as penalty, and this can push all the full-precision (e.g., FP32) weights in the network toward their corresponding integer values after the training.

In addition, an 8-bit uniform quantization is performed on all the weights and intermediate results in the forward propagation through the network. A full-precision (e.g., FP32) compensation scalar is selected to adjust the value range of the weights, such that the value range of the weights are well represented by a predefined maximum bit-width (e.g., 8 bits). In general, 8-bit is a relatively generous bit-width to preserve the salient information of the weight distributions. This quantization will change the gradients in the backward pass to constrain the weight value ranges for the different layers. This quantization bit-width is used later as the maximum allowed reduced bit-width for the reduced adaptive bit-width model.

Below is a sample training process with the integer weight regularization and the 8-bit uniform quantization added.

In this training process, we also start with the following components:

Input: image I_{n×m}, Output: label B_{k×1}, and Model: L-layer neural network.

(x) represents the uniform quantization. (x)=└x/Xₘₐₓ┘*127*(Xₘₐₓ/127.0), where Xₘₐₓ is the current maximal boundary value of x (the whole layer response), which will be updated in the training phase.

```
//Training Phase
While res has not converged:
//Network Forwarding
  x₁ = I
  For i = 1 to L:
    yᵢ = g(Qu(Wᵢ) × xᵢ + Qu(bᵢ) + RIᵢ)
    xᵢ₊₁ = yᵢ
res=½ ∥y_{L}-B∥₂ //a measure of margin of error//
//Backward pass
  For i = L to 1:
    ${W}_{i} = {W}_{i} - γ \frac{\partial res}{\partial {W}_{i , j}} // γ is a parameter$
    ${b}_{i} = {b}_{i} - γ \frac{\partial res}{\partial {b}_{i , j}}$
```

The result of the training includes: Network weight parameters W for each layer, the network bias parameter b for each layer, expressed in full-precision (e.g., single-precision floating point) format. These results differ from the results of the conventional training as described earlier. The full-precision parameters (e.g., weights W and bias b) are pushed toward their nearest integers, with minimal compromise in model accuracy. In order to avoid large information loss, the value range of the integer values is constrained through the 8-bit forward quantization. Before the uniform quantization, the bias term in the convolution layer and fully-connected layer are harmful to the compactness of the network. It is proposed that bias item in the convolutional neural network will not decrease the entire network accuracy. When applying the 8-bit uniform quantization to the weight parameters, the weight parameters are still expressed in full-precision format, but the total number of such response levels are bound by 2⁸−1, with half in the positive and half in the negative. In each iteration of the training phase, this quantization function is applied in each layer in the forward pass. The backward propagation still uses the full-precision numbers for learnable parameter updating. Therefore, with the compensation parameter Xₘₐₓ, the range of the weight integer values is effectively constrained.

After the convergence condition is met (e.g., when res has converged), a full-precision trained learning model (e.g., model 106′) is obtained. This model has high accuracy, and high complexity, and has a large footprint (e.g., computation, power consumption, memory usage, etc.) when testing real-world data.

In some embodiments, network pruning is used to reduce the network complexity. Conventionally, a threshold weight is set. Only weights that are above the threshold are kept unchanged, and weights that below the threshold weight are set to zero, and the connections corresponding to the zero weight are removed from the network. Neurons that are not connected to any other neurons (e.g., due to removal of one or more connections) are effectively removed from the network, resulting in a more compact and sparse learning model. The conventional pruning technique is forced and results in significant information loss, and greatly compromises the model accuracy.

In the present disclosure, a validation dataset is used to perform reinforcement learning, which tests the accuracy of modified versions of the original full-precision trained model (e.g., model 106′) with different combinations of a subset of the connections between the layers. The problem is treated as a weight selection game and reinforcement learning is applied to search for the optimal solution (e.g., optimal combination of connections) that balances both the desire for better model accuracy and model compactness. In some embodiments, the measure of pruning effectiveness Q is the sum of network accuracy (e.g., as measured by the Jensen-Shannon Divergence of the layer responses between the original model and the model with reduced connections) and reciprocal of total connection count. The result of the reinforcement learning is a subset of the more valuable weights in the network. In some embodiments, during each iteration of the reinforcement learning, one connection is removed from the network, or one previously removed connection is added back to the network. The network accuracy is evaluated after each iteration. After training is performed for a while, a slender network with sparse weights (and neurons) will emerge.

The result of the network pruning process includes: Network weight parameters Wᵣ for each layer, the network bias parameter bᵣ for each layer, expressed in full-precision floating point format.

In some embodiments, after the pruned slender full-precision model (e.g., model 106″) goes through an adaptive quantization process to produce the reduced, adaptive bit-width slender INT model (e.g., model 112). The adaptive bit-width of the model refers to the characteristic that the respective bit-width for storing the set of parameters (e.g., weights and bias) for each layer of the model is specifically selected for that set of parameters (e.g., in accordance with the distribution and range of the parameters). Specifically, the validation data set is used as input in a forward pass through the pruned slender full-precision network (e.g., model 106″), and the statistical distribution of the response values in each layer is collected. Then different configurations of bit-width and layer combinations are prepared as candidates for evaluation. For each candidate model, the validation data set is used as input in a forward pass through the candidate model, and the statistical distribution of the response values in each layer is collected. Then, the candidate is evaluated based on the amount of information loss that has resulted from the quantization applied to the candidate model. In some embodiments, Jensen-Shannon divergence between the two statistical distributions for each layer (or for the model as a whole) is used to identify the optimal bit-widths with the least information loss for that layer. In some embodiments, the quantization candidates are generated by using different combinations of bit-widths for all the layers; instead, the weights from different layers are clustered based on their values, and the quantization candidates are generated by using different combinations of bit-widths for all the clusters.

In some embodiments, instead of using linear or uniform quantization on the model parameters for each layer of the model, non-linear quantization is applied to the full-precision parameters of the different layers. Conventional linear quantization does not take into account the distribution of the parameter values, and results in large information losses. With non-uniform quantization (e.g., logarithmic quantization) on the full-precision parameters, more quantization levels are given to sub-levels with larger values, and leads to a reduction in quantization errors. Logarithmic quantization can be expressed in the following formula:

$$y ( x ) = {X}_{ma x} * \frac{log ( 1 + ⌊ R * \frac{x}{{X}_{ma x}} ⌋ )}{log ( 1 + R )} ,$$

which quantizes x in the interval [0, Xₘₐₓ] with R levels. Note that the sign └.┘ means finding the largest integer which is no more than the number inside (e.g., a number with FP32 precision). For example, if we set Xₘₐₓ=105.84 and R=15, we will have y(x) in {0, 26.4600, 41.9381, 52.9200, 61.4382, 68.3981, 74.2826, 79.3800, 83.8762, 87.8982, 91.5366, 94.8581, 97.9136, 100.7426, 103.3763, 105.8400}. Compared with uniform quantization, this non-uniform scheme will distribute more quantization levels for sub-intervals with larger value. In adaptive quantization, Xₘₐₓ is learned under a predefined information loss criterion, not the actual largest value for the interval. Another step taken in practice is that the actual value range may be in [Xₘᵢₙ, Xₘₐₓ], Xₘᵢₙ is subtracted from Xₘₐₓ to normalize its range to be consistent with the above discussion.

As discussed above, in some embodiments, the predefined measure of information loss is the Jensen-Shannon Divergence that measures the difference between two statistical distributions. In this case, the statistical distributions are the collection of full layer responses for all layers (or in respective layers) in the full-precision trained model (e.g., model 106′ or 106″), and the quantized candidate model with a particular combination of bit-widths for its layers. Jensen-Shannon Divergence is expressed in the following formula:

JSD(P∥Q)=½D(P∥M)+½D(Q∥M)

where M=½(P+Q), note that P and Q are two independent data distributions (e.g., the distribution of layer responses for the same layer (or all layers) in the original model and the candidate model). D(P∥Q) is the Kullback-Leibler divergence from Q to P, which can be calculated by:

$$D ( P \vert \vert Q ) = {\sum }_{i}^{ } P ( i ) log ( \frac{P ( i )}{Q ( i )} ) .$$

Note that the Kullback-Leibler divergence is not symmetrical. Smaller the JSD value corresponds to smaller information loss. The candidate selection is based on constraining the information loss under a predefined threshold, or to find a combination of bit-widths that produces the minimum information loss.

In some embodiments, a calibration data set is used as input in a forward propagation pass through the different candidate models (e.g., with different bit-width combinations for the parameters (e.g., weights and bias) of the different layers, and for the intermediate results (e.g., layer responses)).

In the following sample process to select the optimal combinations of bit-widths for the different layers, S is a calibration data set, Statistics_{—i} is the statistical distribution of the i-th layer response. Qₙₒₙ(x, qb) is the non-uniform quantization function, R is the number of quantization levels. qb is the bit-width used for the quantization.

$${Q}_{non} ( x ) = {X}_{ma x} * \frac{log ( 1 + ⌊ R * \frac{x}{{X}_{ma x}} ⌋ )}{log ( 1 + R )} , where R = {2}^{qb} - 1$$

In a sample adaptive bit-width non-uniform quantization process, the base model is either the full-precision trained model 106′ or the pruned slender full precision model 106″, with their respective sets of weights Wi (or Wrᵢ) and bias bᵢ (or brᵢ) for each layer i of the full-precision model.

```
For IzϵS: // S is the calibration data set
For i = 1 to L:
  yᵢ=g(Wᵢ×xᵢ+bᵢ)
xᵢ₊₁=yᵢ
Statistics_i=Statistics_i ∪ yᵢ
For i = 1 to L:
For qb1 = 1 to 8: // quantization bit-width candidates for weights
For qb2 = 1 to 8: // quantization bit-width for layer response
  W_{q,}=Q_{Non}(Wᵢ, qb1), b_{q,i}=Q_{Non}(bᵢ, qb1)
  Stat_{q,}=Q_{Non}(W_{q,i}×xᵢ+bᵢ, qb2)
  Inf_tmp = InformationLoss(Stat_{q,i}, Statistics_i)
  If Inf_tmp < Inf_min:
    W_{opt,i}=W_{q,i}, b_{opt,i}=b_{q,i}
    qb_{opt,}=qb2
    Inf_min = Inf_tmp
```

The result of the above process is the set of quantized weights W_{opt,i} with the optimal quantization bit-width(s) for each layer i, and the set of quantized bias b_{opt,i} with the optimal quantization bit-width(s) for each layer i. The adaptive bit-width model 112 is thus obtained. In addition, the optimal quantization bit-width for the layer response qb2 is also obtained.

In the model deployment phase, the reduced, adaptive bit-width model obtained according to the methods described above (e.g., model 112) is used on a model deployment system (e.g., a portable electronic device) to produce an output (e.g., result 118) corresponding to a real-world input (e.g., test data 114). In the testing phase, the model parameters are kept in the quantized format, and the intermediate results are quantized in accordance with the optimal quantization bit-width qb2 identified during the quantization process (and provided to the model deployment system with the reduced model). (Too Concrete), as shown in the example process below:

```
//Testing Phase: To classify an unseen image Iᵤₙ
  x₁=Iᵤₙ
  For i = 1 to L:
  yᵢ=(Q_{Non}(W_{opt,i}×xᵢ+b_{opt,i}, qb2ₒₚₜ))
  xᵢ₊₁=yᵢ
  Return y_{L}
```

The above model is much more compact than the original full precision trained model (e.g., model 116′), and the computation is performed using integers as opposed to floating point values, which further reduces the computation footprint and improves the speed of the calculations. Furthermore, certain hardware features can be exploited to further speedup the matrix manipulations/computations with the reduced bit-widths and use of integer representations. In some embodiments, the bit-width selection can be further constrained (e.g., even numbers for bit-width only) to be more compatible with the hardware (e.g., memory structure) used on the deployment system.

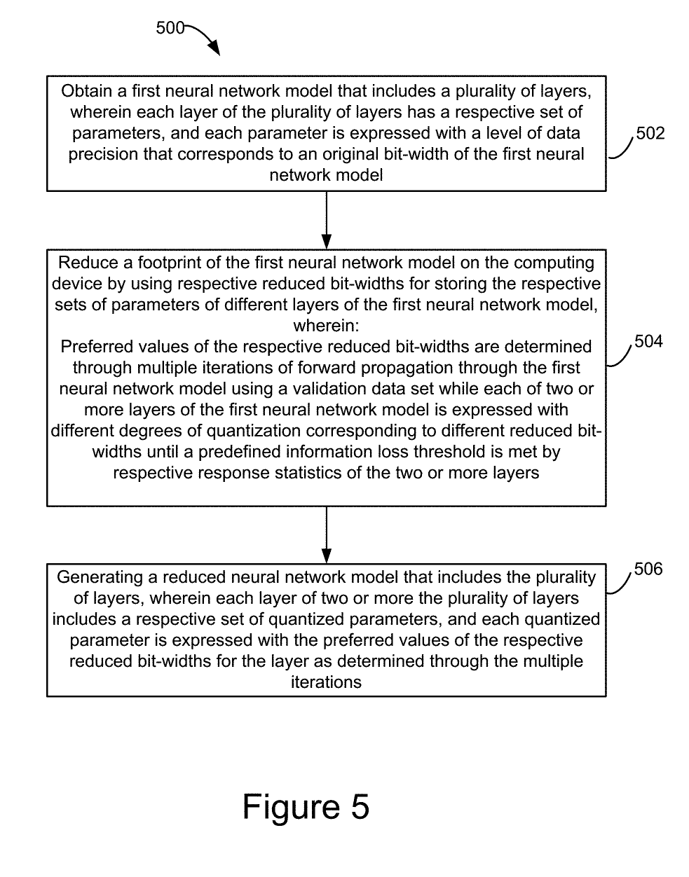

FIG. 5 is a flow diagram of an example process 500 implemented by a model generation system (e.g., model generation system 102 or 200) in accordance with some embodiments. In some embodiments, example process 500 is implemented on a server component of the machine learning system 100.

The process 500 provides an adaptive bit-width neural network model on a computing device. At the computing device, wherein the computing device has one or more processors and memory: the device obtains (502) a first neural network model (e.g., a trained full-precision model 160′, or a pruned full-precision model 160″) that includes a plurality of layers, wherein each layer of the plurality of layers (e.g., one or more convolution layers, a pooling layer, an activation layer, etc.) has a respective set of parameters (e.g., a set of weights for coupling the layer and its next layer, a set of network bias parameters for the layer, etc.), and each parameter is expressed with a level of data precision (e.g., as a single-precision floating point value) that corresponds to an original bit-width (e.g., 32-bit or other hardware-specific bit-widths) of the first neural network model (e.g., each parameter occupies a first number of bits (e.g., occupying 32 bits, as a 32 bits Floating Point number) in the memory of the computing device).

The device reduces (504) a footprint (e.g., memory and computation cost) of the first neural network model on the computing device (e.g., both during storage, and, optionally, during deployment of the model) by using respective reduced bit-widths for storing the respective sets of parameters of different layers of the first neural network model, wherein: preferred values (e.g., optimal bit-width values that have been identified using the techniques described herein) of the respective reduced bit-widths are determined through multiple iterations of forward propagation through the first neural network model using a validation data set while each of two or more layers of the first neural network model is expressed with different degrees of quantization corresponding to different reduced bit-widths until a predefined information loss threshold (e.g., as measured by the Jensen-Shannon Divergence described herein) is met by respective response statistics of the two or more layers.

The device generates (506) a reduced neural network model (e.g., model 112) that includes the plurality of layers, wherein each layer of two or more the plurality of layers includes a respective set of quantized parameters (e.g., quantized weights and bias parameters), and each quantized parameter is expressed with the preferred values of the respective reduced bit-widths for the layer as determined through the multiple iterations. In some embodiments, the reduced neural network model is deployed on a portable electronic device, wherein the portable electronic device processes real-world data to generate predicative results in accordance with the reduced model, and wherein the intermediate results produced during the data processing is quantized in accordance with an optimal reduced bit-width provided to the portable electronic device by the computing device.

In some embodiments, a first layer (e.g., i=2) of the plurality of layers in the reduced neural network model (e.g., model 112) has a first reduced bit-width (e.g., 4-bit) that is smaller than the original bit-width (e.g., 32-bit) of the first neural network model, a second layer (e.g., i=3) of the plurality of layers in the reduced neural network model (e.g., model 112) has a second reduced bit-width (e.g., 6-bit) that is smaller than the original bit-width of the first neural network model, and the first reduced bit-width is distinct from the second reduced bit-width in the reduced neural network model.

In some embodiments, to reduce the footprint of the first neural network includes: for a first layer of the two or more layers that has a first set of parameters (e.g., a set of weights and bias(es)) expressed with the level of data precision corresponding to the original bit-width of the first neural network model: the computing device collects a respective baseline statistical distribution of activation values for the first layer (e.g., statistics_i) as the validation data set is forward propagated as input through the first neural network model, while the respective sets of parameters of the plurality of layers are expressed with the original bit-width (e.g., 32-bit) of the first neural network model; the computing device collects a respective modified statistical distribution of activation values for the first layer (e.g., stat_{q,i}) as the validation data set is forward propagated as input through the first neural network model, while the respective set of parameters of the first layer are expressed with a first reduced bit-width (e.g., W_{q,i} and b_{q,i}) that are smaller than the original bit-width of the first neural network model; determining a predefined divergence (e.g., Inf_tmp=InformationLoss (stat_{q,I} , statistics_i)) between the respective modified statistical distribution of activation values for the first layer and the respective baseline statistical distribution of activation values for the first layer; and the computing device identifies a minimum value of the first reduced bit-width for which a reduction in the predefined divergence due to a further reduction of bit-width for the first layer is below a predefined threshold.

In some embodiments, expressing the respective set of parameters of the first layer with the first reduced bit-width includes performing non-uniform quantization (e.g., logarithmic quantization Qₙₒₙ( . . . )) on the respective set of parameters of the first layer to generate a first set of quantized parameters for the first layer, and a maximal boundary value (e.g., Xₘₐₓ) for the non-uniform quantization of the first layer is selected based on the baseline statistical distribution of activation values for the first layer during each forward propagation through the first layer.

In some embodiments, obtaining the first neural network model that includes the plurality of layers includes: during training of the first neural network: for a first layer of the two or more layers that has a first set of parameters expressed with the level of data precision corresponding to the original bit-width of the first neural network model: obtaining an integer regularization term (e.g., RIᵢ) corresponding to the first layer (e.g., layer i) in accordance with a difference between a first set of weights (e.g., Wᵢ) that corresponds to the first layer and integer portions of the first set of weights (e.g., └Wᵢ┘) (e.g., RIᵢ=½∥Wᵢ−└Wᵢ┘∥2); and adding the integer regularization term (e.g., RIᵢ) to a bias term during forward propagation through the first layer (with the 8-bit uniform quantization applied to the weights and the bias term) such that gradients during backward propagation through the first layer are altered to push values of the first set of parameters toward integer values.

In some embodiments, obtaining the first neural network model that includes the plurality of layers includes: during training of the first neural network: for the first layer of the two or more layers that has a first set of parameters expressed with the level of data precision corresponding to the original bit-width of the first neural network model, performing uniform quantization on the first set of parameters with a predefined reduced bit-width (e.g., 8-bit) that is smaller than the original bit-width of the first neural network model during the forward propagation through the first layer.

In some embodiments, obtaining the first neural network model that includes the plurality of layers includes: during training of the first neural network: for the first layer of the two or more layers that has a first set of parameters expressed with the level of data precision corresponding to the original bit-width of the first neural network model, forgoing performance of the uniform quantization on the first set of parameters with the predefined reduced bit-width during the backward propagation through the first layer.

The example process 500 merely covers some aspects of the methods and techniques described herein. Other details and combinations are provided in other parts of this specification. In the interest of brevity, the details and combinations are not repeated or exhaustively enumerated here.

It should be understood that the particular order in which the operations have been described is merely an example and is not intended to indicate that the described order is the only order in which the operations could be performed. One of ordinary skill in the art would recognize various ways to reorder the operations described herein. The operations in the information processing methods described above are, optionally implemented by running one or more functional modules in information processing apparatus such as general purpose processors or application specific chips.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method of providing an adaptive bit-width neural network model on a computing device, comprising:
at the computing device, wherein the computing device has one or more processors and memory:
obtaining a first neural network model that includes a plurality of layers, wherein each layer of the plurality of layers has a respective set of parameters, and each parameter is expressed with a level of data precision that corresponds to an original bit-width of the first neural network model;
reducing a footprint of the first neural network model on the computing device by using respective reduced bit-widths for storing the respective sets of parameters of different layers of the first neural network model, wherein:
preferred values of the respective reduced bit-widths are determined through multiple iterations of forward propagation through the first neural network model using a validation data set while each of two or more layers of the first neural network model is expressed with different degrees of quantization corresponding to different reduced bit-widths until a predefined information loss threshold is met by respective response statistics of the two or more layers; and
generating a reduced neural network model that includes the plurality of layers, wherein each layer of two or more the plurality of layers includes a respective set of quantized parameters, and each quantized parameter is expressed with the preferred values of the respective reduced bit-widths for the layer as determined through the multiple iterations.

2. The method of claim 1, wherein:
a first layer of the plurality of layers in the reduced neural network model has a first reduced bit-width that is smaller than the original bit-width of the first neural network model,
a second layer of the plurality of layers in the reduced neural network model has a second reduced bit-width that is smaller than the original bit-width of the first neural network model, and
the first reduced bit-width is distinct from the second reduced bit-width in the reduced neural network model.

3. The method of claim 1, wherein reducing the footprint of the first neural network includes:
for a first layer of the two or more layers that has a first set of parameters expressed with the level of data precision corresponding to the original bit-width of the first neural network model:
collecting a respective baseline statistical distribution of activation values for the first layer as the validation data set is forward propagated as input through the first neural network model, while the respective sets of parameters of the plurality of layers are expressed with the original bit-width of the first neural network model;
collecting a respective modified statistical distribution of activation values for the first layer as the validation data set is forward propagated as input through the first neural network model, while the respective set of parameters of the first layer are expressed with a first reduced bit-width that are smaller than the original bit-width of the first neural network model;
determining a predefined divergence between the respective modified statistical distribution of activation values for the first layer and the respective baseline statistical distribution of activation values for the first layer; and
identifying a minimum value of the first reduced bit-width for which a reduction in the predefined divergence due to a further reduction of bit-width for the first layer is below a predefined threshold.

4. The method of claim 3, wherein:
expressing the respective set of parameters of the first layer with the first reduced bit-width includes performing non-uniform quantization on the respective set of parameters of the first layer to generate a first set of quantized parameters for the first layer, and
a maximal boundary value for the non-uniform quantization of the first layer is selected based on the baseline statistical distribution of activation values for the first layer during each forward propagation through the first layer.

5. The method of claim 1, wherein obtaining the first neural network model that includes the plurality of layers includes:
during training of the first neural network:
for a first layer of the two or more layers that has a first set of parameters expressed with the level of data precision corresponding to the original bit-width of the first neural network model:
obtaining an integer regularization term corresponding to the first layer in accordance with a difference between a first set of weights that corresponds to the first layer and integer portions of the first set of weights; and
adding the integer regularization term to a bias term during forward propagation through the first layer such that gradients during backward propagation through the first layer are altered to push values of the first set of parameters toward integer values.

6. The method of claim 5, wherein obtaining the first neural network model that includes the plurality of layers includes:
during training of the first neural network:
for the first layer of the two or more layers that has a first set of parameters expressed with the level of data precision corresponding to the original bit-width of the first neural network model, performing uniform quantization on the first set of parameters with a predefined reduced bit-width that is smaller than the original bit-width of the first neural network model during the forward propagation through the first layer.

7. The method of claim 6, wherein obtaining the first neural network model that includes the plurality of layers includes:
during training of the first neural network:
for the first layer of the two or more layers that has a first set of parameters expressed with the level of data precision corresponding to the original bit-width of the first neural network model, forgoing performance of the uniform quantization on the first set of parameters with the predefined reduced bit-width during the backward propagation through the first layer.

8. A computing device, comprising:
one or more processors; and
memory, the memory including instructions, which, when executed by the one or more processors, cause the processors to perform operations comprising:
obtaining a first neural network model that includes a plurality of layers, wherein each layer of the plurality of layers has a respective set of parameters, and each parameter is expressed with a level of data precision that corresponds to an original bit-width of the first neural network model;
reducing a footprint of the first neural network model on the computing device by using respective reduced bit-widths for storing the respective sets of parameters of different layers of the first neural network model, wherein:
preferred values of the respective reduced bit-widths are determined through multiple iterations of forward propagation through the first neural network model using a validation data set while each of two or more layers of the first neural network model is expressed with different degrees of quantization corresponding to different reduced bit-widths until a predefined information loss threshold is met by respective response statistics of the two or more layers; and
generating a reduced neural network model that includes the plurality of layers, wherein each layer of two or more the plurality of layers includes a respective set of quantized parameters, and each quantized parameter is expressed with the preferred values of the respective reduced bit-widths for the layer as determined through the multiple iterations.

9. The computing device of claim 8, wherein:
a first layer of the plurality of layers in the reduced neural network model has a first reduced bit-width that is smaller than the original bit-width of the first neural network model,
a second layer of the plurality of layers in the reduced neural network model has a second reduced bit-width that is smaller than the original bit-width of the first neural network model, and
the first reduced bit-width is distinct from the second reduced bit-width in the reduced neural network model.

10. The computing device of claim 8, wherein reducing the footprint of the first neural network includes:
for a first layer of the two or more layers that has a first set of parameters expressed with the level of data precision corresponding to the original bit-width of the first neural network model:
collecting a respective baseline statistical distribution of activation values for the first layer as the validation data set is forward propagated as input through the first neural network model, while the respective sets of parameters of the plurality of layers are expressed with the original bit-width of the first neural network model;
collecting a respective modified statistical distribution of activation values for the first layer as the validation data set is forward propagated as input through the first neural network model, while the respective set of parameters of the first layer are expressed with a first reduced bit-width that are smaller than the original bit-width of the first neural network model;
determining a predefined divergence between the respective modified statistical distribution of activation values for the first layer and the respective baseline statistical distribution of activation values for the first layer; and
identifying a minimum value of the first reduced bit-width for which a reduction in the predefined divergence due to a further reduction of bit-width for the first layer is below a predefined threshold.

11. The computing device of claim 10, wherein:
expressing the respective set of parameters of the first layer with the first reduced bit-width includes performing non-uniform quantization on the respective set of parameters of the first layer to generate a first set of quantized parameters for the first layer, and
a maximal boundary value for the non-uniform quantization of the first layer is selected based on the baseline statistical distribution of activation values for the first layer during each forward propagation through the first layer.

12. The computing device of claim 8, wherein obtaining the first neural network model that includes the plurality of layers includes:
during training of the first neural network:
for a first layer of the two or more layers that has a first set of parameters expressed with the level of data precision corresponding to the original bit-width of the first neural network model:
obtaining an integer regularization term corresponding to the first layer in accordance with a difference between a first set of weights that corresponds to the first layer and integer portions of the first set of weights; and
adding the integer regularization term to a bias term during forward propagation through the first layer such that gradients during backward propagation through the first layer are altered to push values of the first set of parameters toward integer values.

13. The computing device of claim 12, wherein obtaining the first neural network model that includes the plurality of layers includes:
during training of the first neural network:
for the first layer of the two or more layers that has a first set of parameters expressed with the level of data precision corresponding to the original bit-width of the first neural network model, performing uniform quantization on the first set of parameters with a predefined reduced bit-width that is smaller than the original bit-width of the first neural network model during the forward propagation through the first layer.

14. The computing device of claim 13, wherein obtaining the first neural network model that includes the plurality of layers includes:
during training of the first neural network:
for the first layer of the two or more layers that has a first set of parameters expressed with the level of data precision corresponding to the original bit-width of the first neural network model, forgoing performance of the uniform quantization on the first set of parameters with the predefined reduced bit-width during the backward propagation through the first layer.

15. A non-transitory computer-readable storage medium, storing instructions, which, when executed by one or more processors, cause the processors to perform operations comprising:
obtaining a first neural network model that includes a plurality of layers, wherein each layer of the plurality of layers has a respective set of parameters, and each parameter is expressed with a level of data precision that corresponds to an original bit-width of the first neural network model;
reducing a footprint of the first neural network model on the computing device by using respective reduced bit-widths for storing the respective sets of parameters of different layers of the first neural network model, wherein:
preferred values of the respective reduced bit-widths are determined through multiple iterations of forward propagation through the first neural network model using a validation data set while each of two or more layers of the first neural network model is expressed with different degrees of quantization corresponding to different reduced bit-widths until a predefined information loss threshold is met by respective response statistics of the two or more layers; and
generating a reduced neural network model that includes the plurality of layers, wherein each layer of two or more the plurality of layers includes a respective set of quantized parameters, and each quantized parameter is expressed with the preferred values of the respective reduced bit-widths for the layer as determined through the multiple iterations.

16. The computer-readable storage medium of claim 15, wherein:
a first layer of the plurality of layers in the reduced neural network model has a first reduced bit-width that is smaller than the original bit-width of the first neural network model,
a second layer of the plurality of layers in the reduced neural network model has a second reduced bit-width that is smaller than the original bit-width of the first neural network model, and
the first reduced bit-width is distinct from the second reduced bit-width in the reduced neural network model.

17. The computer-readable storage medium of claim 15, wherein reducing the footprint of the first neural network includes:
for a first layer of the two or more layers that has a first set of parameters expressed with the level of data precision corresponding to the original bit-width of the first neural network model:
collecting a respective baseline statistical distribution of activation values for the first layer as the validation data set is forward propagated as input through the first neural network model, while the respective sets of parameters of the plurality of layers are expressed with the original bit-width of the first neural network model;
collecting a respective modified statistical distribution of activation values for the first layer as the validation data set is forward propagated as input through the first neural network model, while the respective set of parameters of the first layer are expressed with a first reduced bit-width that are smaller than the original bit-width of the first neural network model;
determining a predefined divergence between the respective modified statistical distribution of activation values for the first layer and the respective baseline statistical distribution of activation values for the first layer; and
identifying a minimum value of the first reduced bit-width for which a reduction in the predefined divergence due to a further reduction of bit-width for the first layer is below a predefined threshold.

18. The computer-readable storage medium of claim 17, wherein:
expressing the respective set of parameters of the first layer with the first reduced bit-width includes performing non-uniform quantization on the respective set of parameters of the first layer to generate a first set of quantized parameters for the first layer, and
a maximal boundary value for the non-uniform quantization of the first layer is selected based on the baseline statistical distribution of activation values for the first layer during each forward propagation through the first layer.

19. The computer-readable storage medium of claim 15, wherein obtaining the first neural network model that includes the plurality of layers includes:
during training of the first neural network:
for a first layer of the two or more layers that has a first set of parameters expressed with the level of data precision corresponding to the original bit-width of the first neural network model:
obtaining an integer regularization term corresponding to the first layer in accordance with a difference between a first set of weights that corresponds to the first layer and integer portions of the first set of weights; and
adding the integer regularization term to a bias term during forward propagation through the first layer such that gradients during backward propagation through the first layer are altered to push values of the first set of parameters toward integer values.

20. The computer-readable storage medium of claim 19, wherein obtaining the first neural network model that includes the plurality of layers includes:
during training of the first neural network:
for the first layer of the two or more layers that has a first set of parameters expressed with the level of data precision corresponding to the original bit-width of the first neural network model, performing uniform quantization on the first set of parameters with a predefined reduced bit-width that is smaller than the original bit-width of the first neural network model during the forward propagation through the first layer.
